(19) United States
(12) Patent Application Publication
(10) Pub. No.: US 2006/0287945 A1
(43) Pub. Date: Dec. 21, 2006

(54) TRADING SYSTEM

(76) Inventor: Andrea Spaccatrosi, London (GB)

Correspondence Address: DARBY & DARBY P.C., P. O. BOX 5257, NEW YORK, NY, 10150-5257, US

(21) Appl. No.: 11/424,811

(22) Filed: Jun. 16, 2006

Related U.S. Application Data
(60) Provisional application No. 60/692,354, filed on Jun. 20, 2005.

(51) Int. Cl. G06Q 40/00

(52) U.S. Cl. 705/37

(57) ABSTRACT

The invention provides methods for calculating a trading indicator for the price of a financial series and systems operable in accordance with the method. The trading indicator is calculated based on a measure of a price of a financial series over a time period. The time period is not fixed and is inversely proportional to a volatility measure calculated on the price of the financial series. The price measure may be a moving average.

This application is a Utility patent application based on a previously filed Provisional Application, U.S. Ser. No. 60/692,354 filed Jun. 20, 2005, the benefit of the filing date of which is hereby claimed under 35 U.S.C. 119(e).

### FIELD OF THE INVENTION

This invention relates to a method of financial trading using trading indicators. The invention also includes a computer program and an electronic system for performing the trading method on the price of a financial series or other financial instrument or contract or traded commodity.

### BACKGROUND OF THE INVENTION

There are many theories and financial models that attempt to predict the future structure of a financial market. Most of the technical analysis based on these theories or models attempt to spot a trend in the market using the past behaviour of that particular market. However, financial markets are unpredictable and the past cannot always be used to successfully predict the future. To minimise the possibility of financial loss, caused by the fluctuation of the market, many analytical methods use indicators, which are triggered when the market starts to trend.

Moving averages are one of the most popular and easy to use tools available for the analysis of a financial market. When plotted on a graph with the price of a financial series over time, they can be used as an indicator to show the difference in the price of the series compared to its average value, which has been calculated over a period of time. The beginning of a trend in the increase of the price of a financial series may be indicated when the price crosses from below and rises above the level of the moving average. To benefit or profit from what might be a continuing trend in the price increase of the series, a trader may choose to buy when the price has crossed to a particular level above the moving average. A system employing an indicator can be setup to alert the trader when this happens.

When the price of a financial series crosses from above and falls below the level of the moving average, it may be the beginning of a trend in the decrease in price of a financial series. To avoid loss, a trader may choose to sell when the price of the financial series has crossed to a particular level below the moving average. An indicator can also be setup to alert the trader when this happens.

Moving averages are calculated over a fixed reference period, which, for the price of a series, determines the number of the previous price values that are used as part of the calculation. Generally, moving averages calculated over a longer reference or time period contain more price terms and the most recent price will only have a small effect on the average. Consequently, moving averages with longer time periods are less responsive to a change in price. Conversely, the most recent price has a more significant effect in the calculation of a short moving average (i.e. one calculated over a shorter reference or time period and thus containing fewer price terms) and so, the average responds more quickly to a price change.

The reference or time period chosen for a moving average for a particular market is usually determined empirically to suit that market. Traders try to pick a time period that will optimise their profits. The price changes in some markets often behave in a cyclic manner. For this type of market, usually it is best to use a moving average that is half the length of the cycle that is being tracked. For example, if the peak-to-peak cycle is roughly 30 days then a 15 day reference period for the moving average is usually appropriate. Some traders often shorten the reference period to less than half the peak-to-peak cycle in the hope that they will generate signals slightly ahead of the market. Market cycles vary in length over time, so the trader has to check that the moving average that they are using is still appropriate.

Moving averages are lagging indicators and, irrespective of the time period used in their calculation, always lag behind the price. Despite the lag, moving averages always follow the price when it is trending, and hence are known as trend following indicators.

There are several different types of moving average. Two commonly used moving averages in trading are the simple or arithmetic moving average and the exponential moving average. A simple moving average is the arithmetic mean calculated from a previous price, which is determined by the size of the fixed time period, to the most recent price of a financial series. Each price used in the calculation has an equal weighting with the other prices.

An exponential moving average is calculated by adding a percentage of the moving average calculated for the previous price to a percentage of the most recent price. The weighting applied to the more recent prices helps to reduce the lag of the moving average in response to a change in the price. Generally, the effect of the weighting depends on the size of the time period used to calculate the average. More weight will be applied to the most recent price in a shorter moving average than in a longer one.

Other types of moving average known in the prior art are the triangular moving average, the variable moving average and the weighted moving average. All these types of moving averages can be used in trading as indicators.

Moving averages are generally not used as trading indicators on their own. Losses can result in a ranging market, which is when the price whipsaws or fluctuates above and below the moving average. Most systems employ a moving average combined with a system for identifying fluctuating markets.

One way of identifying a ranging market is to use a filter. Filters are used to eliminate uncertain price signals by providing an objective measure of whether the price is trending and if the trend, and not just a fluctuation, has crossed the moving average. A commonly used filter is based on the closing price of the financial series. The filter requires that a set number of consecutive closing prices all cross the moving average before generating a trading signal. Other similar filters are based on the typical price, median price or a weighted closing price of the series.

Another commonly used filter system is based on the direction of movement of the moving average relative to the price and is known as the moving average directional filter. Trading signals are only generated if the moving average slopes in the direction of the trend.

An alternative to a trading system having only a single moving average with a filter is to use a system based on two moving averages. In such a system, there is a moving average calculated over a long time period and a moving average calculated over a short time period. The long moving average provides an indication of the typical behaviour of the price of the financial series, based on its recent history. The shorter moving average provides an indicator that responds more rapidly to a change in the market, so that it can detect a change that could be the start of a trend. The relative positions of the long and short moving averages, and the position of the price of the financial series provides information to a trader about the state of the market.

A trading signal to buy is triggered when the short or fast responding moving average crosses above the slow moving average from below. Conversely, a selling signal is triggered when the short moving average drops below the long moving average.

There are more sophisticated systems that employ three or more moving averages, each of the moving averages being calculated over a fixed time period. Like the system with two moving averages, the relative positions of the moving averages with respect to one another and the position of the market are used to generate trading signals.

Another indicator commonly used by traders to assess the market is a measure known as the volatility. Volatility measures play an important role in financial engineering and especially in the valuation of various forms of options. The volatility is a measure of the fluctuation of a market in a given time period. Typically, it will be a measure of the standard deviation for the price of e.g. a security or other financial instrument or commodity and provides an indication of the amount that a price has fluctuated over a given period of time. The volatility of the price of a commodity or the price of a security or other financial instrument may be defined as the standard deviation of the logarithm of the rate of change of two prices. Markets that fluctuate will have a larger standard deviation about the mean value of the price and so have larger volatility compared to markets where the price is in a relatively steady state.

Volatility measures provide the basis of many other forms of technical analysis for trading systems known in the art. Bollinger bands are an example of an indicator based on a measure of volatility. Bands are plotted at two standard deviations above and below an exponential moving average (EMA), usually a 20 day EMA. Using two standard deviations ensures that 95% of the price data will fall between the two trading bands. The standard deviation is a volatility measure and moves or self-adjusts depending on the state of the market. In volatile markets the standard deviation is larger and so the bands widen. During calmer periods, the volatility of the market decreases and the bands narrow. The bands may be used in a number of ways. Perhaps the simplest method of trading using the bands is by setting the upper and lower bands as price targets. Although, as a general rule, prices are considered to be overbought when they touch the upper band and oversold when they touch the lower band.

There are numerous other indicators used by traders, some of which are based on volatility measures or moving averages with fixed time periods. Examples of some of these common indicators are Chaikin's volatility index, moving average convergence/divergence (MACD), money flow index (MFI), on balance volume (OBV), price momentum, relative strength index (RSI), Williams % R, fast and slow stochastic oscillators, and support and resistance lines.

### SUMMARY OF THE INVENTION

The invention provides a method for calculating a trading indicator for the price of a financial series. The level, or position when plotted as a graph, of the trading indicator relative to that of the price of the financial series, provides an indication of whether the market is beginning to trend and whether a financial instrument or tradable commodity should be bought or sold. In principle, the invention could be applied to any historical data series that is updated at regular intervals. It is preferred that the invention is used on a financial series.

The term price of a financial series as used herein may refer to any financial instrument or tradable economic commodity or any security that has a traded price and whose market is sufficiently liquid to avoid slippage at the execution of a trade. Suitable examples are accumulated values, exchange rates, interest rates, options, share prices, bond index, stock index, securities and futures. The term price of a financial series also includes securities that are derived from traded securities e.g. a spread of two interest rates even if they are not traded as a package on any exchange.

In one aspect, the invention proposes calculating a trading indicator based on a measure of a price of a financial series over a time period, where the time period is not fixed and is inversely proportional to a volatility measure calculated on the price of the financial series.

In some embodiments the measure of the price of the financial instrument on which the trading indicator is based is a moving average. In this case, the method of calculating the trading indicator comprises the step of calculating a moving average over a time period on the price of a financial series, where the time period is not fixed and is inversely proportional to a volatility measure calculated on the price of the financial series.

The term time period of a moving average as used herein refers to the number of consecutive price terms taken from the market from a given time interval, which are then used to calculate the moving average. For example, in a market having a series of prices represented by Qₜ, Qₜ₋₁, Qₜ₋₂, Qₜ₋₃, . . . Qₜ₋ₙ, a simple moving average “A” having a reference or time period of, say, 4 would then be calculated using an expression of the form:
A=(Qₜ+Qₜ₋₁+Qₜ₋₂+Qₜ₋₃)/4

More generally, the “time period” of any measure of the price of the financial series (for convenience referred to in the following as s “price measure”) may refer to the number of consecutive price terms taken from the market, which are then used to calculate the price measure. Taking again the simple example of a series of prices represented by Qₜ, Qₜ₋₁, Qₜ₋₂, Qₜ₋₃, . . . Qₜ₋ₙ, a price measure having a reference or time period of 4 would then be calculated as a function of Qₜ, Qₜ₋₁, Qₜ₋₂ and Qₜ₋₃

In markets where the price of a financial series fluctuates, the volatility measure is larger than in more stable or steady state type markets. In a trading indicator of the present invention, when a market becomes more volatile, an increase in the volatility measure reduces the time period used for calculating the price measure (e.g. moving average). Shortening the time period makes the price measure more responsive to changes in the price and allows the indicator to follow the price more closely. Potential losses due to price fluctuations, such as when the price spikes up or down by a small amount, can be minimised when the indicator follows the price more closely. To trigger the indicator into providing a buy or sell signal, a sudden change in price must be reasonably significant and more than a mere fluctuation, which is desirable if a trader is to profit from a trend in the market.

Conversely, if a market settles down and is in a relatively steady state, the volatility measure for the price of a financial series will decrease. For markets in a relatively calm or steady phase, the trend may be a gradual change in the price. To enable a trader to profit from such a trend, indicators based on a price measure that is influenced by volatility in accordance with the present invention can be less responsive to a change in price so that they can detect or be triggered by smaller or gradual price changes. For example, in the case where the price measure is a moving average, a decrease in the volatility measure increases the time period of the moving average, which makes the moving average longer. A longer moving average is less responsive to changes in the price of the market because it is more heavily weighted by the previous performance of the price of the financial series. When compared to a more volatile market, the indicator will show a greater “lag” behind a change in price, so that if the change is gradual or relatively small the indicator will detect the change or trigger a signal.

Thus it will be appreciated that the present invention provides a method for calculating an indicator based on a moving average or other price measure that does not have a fixed time period, which allows the indicator to self-adjust its responsiveness to the market, as the nature of the market changes.

The present invention includes a method for calculating a trading indicator for the price of a financial series, where there are a series of prices represented by Qₜ, Qₜ₋₁, Qₜ₋₂, Qₜ₋₃, . . . Qₜ₋ₓ, and where Qₜ is the most recent price of the series, comprising the steps of:
(i) calculating a volatility measure V₁ of the financial series from the most recent price Qₜ and a previous price Qₜ₋ₓ,
(ii) calculating a ratio R₁, wherein R₁=M₁/V₁ and where M₁ is a multiplier,
(iii) calculating a moving average Al (or another price measure) over a series of previous prices to the most recent price Qₜ, wherein said ratio R₁ is the number of time periods of said moving average, and
   where the trading indicator is based on the moving average A₁ (or other price measure).

In principle, there are a number of ways in which a volatility measure V₁ of the market may be calculated. The method of the present invention includes other methods for calculating a volatility measure known in the art. The volatility measure is calculated over the price of a financial series from the most recent price of the financial series Qₜ to a previous price Qₜ₋ₓ. Preferably, the volatility measure V₁ is based on a formula for calculating a biased standard deviation, a non-biased standard deviation or is calculated using the formula given by (I) below, which is commonly used in economic theory for calculating the volatility:

$${V}_{1} = std ( log ( \frac{{Q}_{t}}{{Q}_{t - x}} ) ) \qquad ( I )$$

where V₁ is the volatility, Qₜ is the most recent price of the financial series and “std” is the operation of performing a standard deviation.

More preferably, the volatility measure is based on the formula for calculating a non-biased standard deviation.

A ratio R₁ is calculated that is inversely proportional to the volatility measure V₁, so that as the volatility increases, ratio R₁ decreases. The ratio R₁ is a number that provides the reference or time period for the number of price values that are used in calculating the moving average A₁ (or other price measure) given the level of volatility V₁.

To calculate the ratio R₁, a multiplier M₁ must be selected. The multiplier M₁ is a constant that is selected empirically to optimise the reference or time period of the moving average (or other price measure) to the structure or volatility of the market. The size of the multiplier chosen for calculating the ratio may depend on the nature of the indicator to be used in trading, the type of the market, the timeframe of the market that is suitable for making profitable trades and the pricing unit of the instrument e.g. in the Bund 121,5 or DAX 4220 systems, the multiplier may incorporate a conversion factor for the change of currency, such as 0.6911 Euros to the British pound.

The reference or time period of a moving average (or other price measure), such as A₁ in the present method, must be an integral number i.e. there must be an integral number of price terms. Once the ratio R₁ has been calculated, the result may be rounded up or down to provide an integral value for R₁. Preferably, the result of the calculation for R₁ is rounded up e.g. if the ratio calculated for R₁ is 8.9, then it would be rounded up so that R₁ would equal 9.

The nature of a particular financial market may undergo a significant change in structure after the multiplier M₁ for the ratio R₁ has been selected. This change may cause an increase in the volatility so that the ratio R₁ will become less than one. The price measure, e.g. moving average A₁, cannot be calculated using a time period of less than one. It is preferred that the minimum value or threshold level for the time period of the moving average is at least one. This prevents R₁ from falling below one. When the time period is one, the moving average is equal to the most recent price Qₜ of the financial series. Alternatively, M₁ can be changed to another value that will reflect the new behaviour of the market.

Any of a number of suitable price measures may be used in embodiments of the present invention. One suitable price measure, exemplified already above, is a moving average. The type of moving average used for calculating the trading indicator can be any type of average known in the art, such as simple moving average, an exponential moving average, a triangular moving average, or a weighted moving average. Preferably, the moving average used in the method is a simple moving average or an exponential moving average. More preferably a simple moving average is used in the method.

Another price measure that may be used in embodiments of the present invention for the calculation of the trading indicator is the volatility of the price of the financial series. That is, the trading indicator can be based on a volatility measure that is calculated over a time period that is itself dependent on a volatility measure (the volatility measure used to determine the time period being calculated, for example, in the manner described above).

A trading indicator in accordance with the present invention and calculated using volatility as the price measure can be particularly useful for trading in markets at times where there is no easily discernible trend in price, especially as moving average based indicators perform less well in such market conditions. Typically a trade will be initiated when there is a predetermined increase in the volatility. Conversely, where the volatility clusters (indicating the market is ‘going nowhere’) no trade will be made (or other indicators may be used to determine whether a trade should be made).

It is preferred that a trading indicator calculated by the method of the invention is used in conjunction with another trading indicator. This other trading indicator may be a second financial trading indicator known in the art, such as a filter or a moving average that has a fixed time period for example. It is preferred that a trading indicator of the present invention is used in conjunction with Bollinger bands.

Another embodiment of the present invention is a method for calculating a trading indicator for the price of a financial series, where there are a series of prices represented by Qₜ, Qₜ₋₁, Qₜ₋₂, Qₜ₋₃, . . . Qₜ₋ₓ, . . . Q_{t-y}, where Qₜ is the most recent price of the series and where Q_{t-y} represents the price of the series from a different time period to Qₜ₋ₓ. The method for calculating a trading indicator comprises the steps of:
(i) calculating a volatility measure V₁ of the financial series from the most recent price Qₜ and a previous price Qₜ₋ₓ,
(ii) calculating a second volatility measure V₂ of the financial series from the most recent price Qₜ and a previous price Q_{t-y},
(iii) calculating ratios R₁ and R₂, wherein R₁=M₁/V₁ and R₂=M₂/V₂ and where M₁ and M₂ are multipliers such that one of R₁ or R₂ is larger than the other,
(iv) calculating a first moving average A₁ (or first other price measure) over a series of previous prices to the most recent price Qt, wherein said ratio R₁ is the number of price time periods of said moving average A₁ (or first other price measure),
(v) calculating a second moving average A₂ (or second other price measure) over a series of previous prices to the most recent price Qₜ, wherein said ratio R₂ is the number of closing price time periods of said moving average A₂ (or second other price measure), and wherein
   said trading indicator is based on the first and second moving averages A₁ and A₂ (or first and second other price measures) This embodiment of the invention is a method for calculating a trading indicator based on moving averages (or other price measures) that are dependent on a volatility measure of the price of the financial series. One of the moving averages (or, more generally, price measures) is calculated over a longer reference period than the other. An indicator is based on these multiple moving averages or other price measures.

For example, in the case of moving averages a trading signal to buy may be triggered when the more responsive moving average, which has the shorter reference period, crosses above the slower or less responsive moving average from below. Conversely, a selling signal is triggered when the short moving average drops below the long moving average.

The volatility measures V₁ and V₂ can each independently be calculated using methods for determining the volatility that are known in the art. The volatility measures are calculated over the price of a financial series from the most recent price Qₜ to a previous price Qₜ₋ₙ. Preferably, the volatility measure V₁ and/or V₂ are each independently based on a formula for calculating a biased standard deviation, a non-biased standard deviation or is calculated using a formula for volatility given below:

$$V = std ( log ( \frac{{Q}_{t}}{{Q}_{t - n}} ) )$$

where Qₜ is the most recent price of the financial series, Qₜ₋ₙ is a price from an earlier period of time, and “std” is the operation of a standard deviation. Even more preferably, the volatility measures V₁ and V₂ are based on the formula for calculating a non-biased standard deviation.

To calculate the ratios R₁ and R₂, multipliers M₁ and M₂ must be selected. Multipliers M₁ and M₂ are constants that are selected empirically in order to optimise the reference or time period of their respective price measures, e.g. moving averages, A₁ or A₂, to the structure or volatility of the market. The size of the multiplier chosen for calculating each ratio may depend on the nature of the indicator to be used in trading, the type of the market, the timeframe of the market that is suitable for making profitable trades and the pricing unit of the instrument e.g. in the Bund 121,5 or DAX 4220 systems, the multiplier may incorporate a conversion factor for the change of currency, such as 0.6911 Euros to the British pound.

The reference or time period of a moving average or other price measure, such as A₁ or A₂ in the present method, must be an integral number i.e. there must be an integral number of price terms for performing the moving average calculation. The outcome of the calculation for the ratios R₁ and/or R₂ should be rounded up or down to provide an integral value. Preferably, the result of the calculation for R₁ and R₂ is rounded up e.g. if the ratio calculated for R₁ is 8.9, then R₁ would be rounded up to 9.

Generally, the multipliers M₁ and M₂, and the time periods for calculating V₁ and V₂ are chosen so that the time periods for A₁ and A₂ are different. If the market structure is such that the volatility measure V₁ is likely to equal V₂, the multipliers M₁ and M₂ are selected to be different. However, the invention does not exclude multipliers M₁ and M₂ from being equal.

One of R₁ or R₂ must be suitably larger than the other so that one of A₁ or A₂ is a moving average calculated over a short time period and the other of A₁ or A₂ is calculated over a long time period. The same considerations apply to other price measures.

It is possible that the structure of the market may change significantly some time after the ratio multipliers have been selected. This change in market structure may result in the volatility of the price of the financial series increasing dramatically. An increase in volatility will decrease the ratios R₁ and R₂. This is particularly important for the ratio used for calculating the short moving average (or other price measure). Price measures such as a moving average can only be calculated if the ratio is at least one. An aspect of the present method is to provide a minimum value or threshold level for the ratios R₁ and/or R₂, particularly when the ratio is used as the time or reference period of a short moving average. In particular, the ratio R₁ or R₂ for the short moving average must not fall below 1. The minimum threshold level for both ratios must be at least one.

Where the price measures are moving averages, the formula or type of moving average used for calculating the trading indicators can be any type of average known in the art, such as simple moving average, an exponential moving average, a triangular moving average, or a weighted moving average. Moving averages A₁ and A₂ can be different types of moving average. It is preferable that A₁ and A₂ are the same type of moving average. Preferably, moving averages A₁ and A₂ used in the method are simple moving averages or exponential moving averages. More preferably A₁ and A₂ are calculated as simple moving averages in the method of the invention.

A trading indicator calculated by the method of the previous embodiment may be used in conjunction with other, known types of trading indicator. These additional trading indicators are financial trading indicators already known in the art, such as a filter or a moving average that has a fixed time or reference period. It is preferred that the trading indicators of the present invention are used in conjunction with Bollinger bands.

It is preferable that the prices of a financial series used for performing the methods of the present invention are taken from or are data sampled over regular time intervals. In real life, the price of a financial series may be updated at regular intervals or will vary continuously during a day, such as in the Bund 30 future system where the price of the financial series continuously changes. The methods of the present invention can be used with a system that continuously updates or is updated regularly over a very small time period.

The execution of a trade costs money and profits may be maximised by minimising the total number of trades. The method of the present invention is performed using price data updated over regular time periods. If the price of a financial series varies continuously or is regularly update over small time intervals, then the price data may be sampled over larger regular time periods as part of the method of the present invention. The sampled price data from the financial series is then used for calculating an indicator according to the methods described herein.

Not all financial series vary continuously or are regularly updated over a small time interval. In this type of financial series the price data may be used directly with the methods of the present invention.

It is preferred that the price updates are from the same time interval for each time period. If the price updates are obtained over longer time intervals, such as once or twice a day, it is preferred that the price of the financial series used in the methods of the invention are the prices from the start and/or close of the financial day.

Another aspect of the invention is an electronic financial trading system for buying or selling a financial instrument or a tradable commodity. The system comprises means for performing the method of the previous embodiments of the invention.

An electronic system of the present invention may also include a component for retrieving the most recent closing price of the financial series from a data source or a data provider. The system is connected through a network to a data source that provides, or allows, the system to retrieve price data, in particular the most recent price, of a financial series. The system may also be able to receive price data that has been sent by a data provider. After obtaining the information, the system is able to automatically update the list of prices for the series with the most recent price and will then calculate an updated trading indicator according to embodiments of the methods of the invention.

It is preferred that the system has a network connection that enables a financial instrument or tradable commodity to be bought or sold through the system. The system may further include a user interface for a trader to be able to buy or sell a financial instrument or tradable commodity. The system's user interface may include a means for setting or adjusting the tolerance and/or other parameters of a trading indicator calculated according to the methods of the present invention. A visual and/or sound alert may also be generated by the user interface when an indicator is triggered. The system can be setup so that it can automatically trade on the price of a financial series based on a trading indicator calculated according to all embodiments of the methods of the invention.

The system may further comprise a data server and at least one terminal that is networked to the data server. The methods of the present invention may be performed on the data server and the resulting indicator or trigger alert may appear on a terminal or terminals networked to the server. Trades may be executed from the terminal. The terminal may connect with the data server, which may then execute the trade. Alternatively, each terminal may have its own network connection for executing trades. The data server can be located in a different country to a networked terminal.

Another aspect of the invention is a computer program for calculating a trading indicator for the price of a financial series using a method of the present invention. The computer program is able to perform the methods of the present invention when run. The computer program may be used in combination with an electronic system of the invention, or a computer or network. The invention also includes a computer program product, where the computer program for performing a method of the present invention is stored on computer readable media.

### BRIEF DESCRIPTION OF THE DRAWINGS An embodiment of the invention is described below, by way of example, with reference to the accompanying drawings, in which:

FIG. 1 is a table extracted from a spreadsheet for performing a method of the invention;

FIG. 2 is a graph showing the levels of the price of a financial series, the long and short moving averages and the level of the moving average used for calculating the volatility measures;

FIG. 3 is a flow illustration of the steps involved in a system for calculating a trading indicator and deciding whether to make a trade based on the calculated indicator;

FIG. 4 is a scheme showing a networked computer system for trading using a method of the invention.

### DETAILED DESCRIPTION OF EMBODIMENTS AND THE DRAWINGS

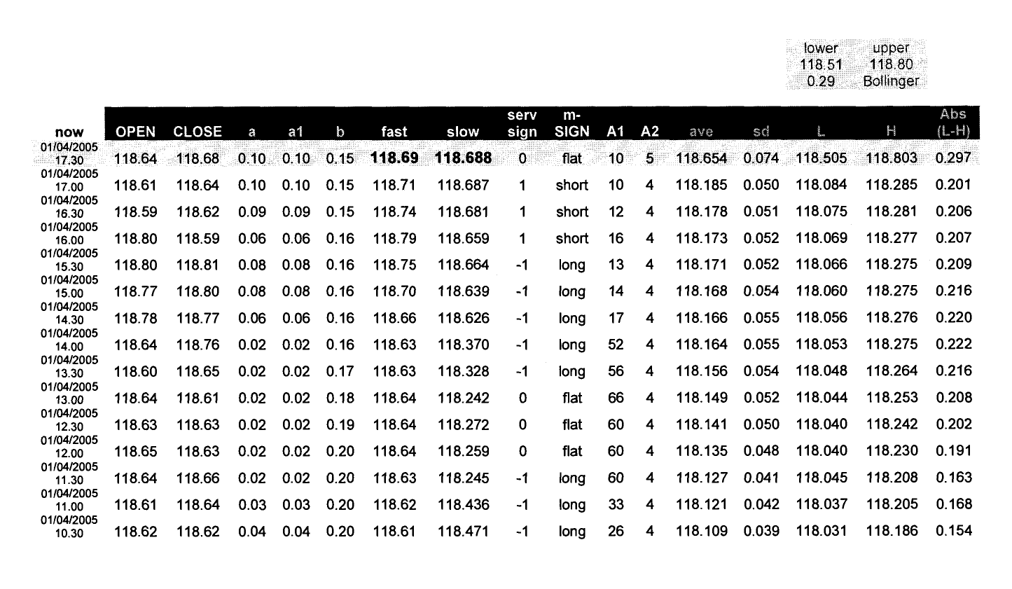

FIG. 1 is a table extracted from a spreadsheet created using the Microsoft Excel (registered trade mark) program and contains price data from the Bund 30 financial series. Data from the Bund 30 futures financial series was sampled every 30 minutes and was then automatically entered into the top row of the table. The date and time of each price data point obtained for this financial series is listed under the column headed “now”. For this particular financial series, the price data was sampled from 7.00 am in the morning until 5.30 pm at 30 minute intervals. The most recent price of the financial series (Qₜ) is entered into the top row under the column headed “CLOSE”. The previous price or starting price for the financial series (Qₜ₋₁) is listed in the column headed “OPEN”.

Volatility measures, corresponding to V₁ and V₂ of the invention, were calculated using the most recent price data (Qₜ), as listed in FIG. 1 under the column headed “CLOSE”. The volatility measures based on the most recent price data are listed under the columns headed “a” and “b”. “a” is a volatility measure calculated over 5 price terms. “b” is a volatility measure calculated over 40 price terms. Both volatility measures have been calculated using the “STDEV” function in MS Excel. This function computes the standard deviation using the non-biased or “n-1” formula. The column “a1” sets a minimum threshold level for the volatility measure listed in “a”. If “a” drops below the “a1” threshold, which has been set in this example to 0.0005, then the “al” threshold value will be used for calculating the time period.

The time periods for the moving averages, which correspond to the ratios R₁ and R₂ of the invention, are calculated from the volatility measures “a” and “b”. The time periods (R₁ and R₂) are listed in the columns “A1” and “A2” of the table. “A1” is the time period that has been calculated using the volatility measure “a”. Whereas, “A2” is based on the volatility measure “b”. The multipliers for calculating “A1” and “A2” are 1 and 0.6 respectively. Typically, the result of the calculation for the ratios R₁ and R₂ will not be an integer and so will have to be rounded up or down. In this example the results in the columns “A1” and “A2” have been rounded down using the “Int” function in Microsoft Excel (registered trade mark).

The slow moving average, which is calculated using a larger number of price terms than the fast moving average, is then calculated. In FIG. 1, the time period for calculating this moving average is listed in the “A1” column. The result of the calculation for the slow moving average is listed under the column headed “slow”. Similarly, a fast or short moving average is also shown in the table of FIG. 1 under the column headed “fast”. This average is calculated using the time period listed in the “A2” column.

The next column “serv sign” generates a number based on the relative levels of the “fast”, “slow” and “CLOSE” data points i.e. the relative position of the fast moving average (weighted by the previous closing price), the slow moving average and the most recent price of the financial series. If the value in the top row of the “CLOSE” column exceeds the values in the “slow” and “fast” columns, then “−1” will be generated in the “serv sign” column. If the price data in the “CLOSE” column is less than both the values in the “slow” and “fast” columns, then a signal of +1 is generated in the “serv sign” column. If the “CLOSE” price is between the “fast” and the “slow” value, a 0 will be generated in the “serv sign” column.

A trading indicator based on the slow and fast moving averages is shown in the column headed “m-SIGN”. The indicator is based on the value generated in the “serv sign” column of the table. If the “serv sign” column reads −1, then the top row of the “m-SIGN” column will indicate that the market is “long” and that the trader should buy. Similarly, if a “+1” is generated in the “serv sign” column, a “short” indicator signal will be generated in the “m-SIGN” column and that a trader should sell. However, if a “0” is listed in the “serv sign” column, a “flat” signal will be generated, which means that the trader should do nothing.

The spreadsheet table also contains Bollinger bands as an example of other prior art indicators that can be used in combination with the invention. However, the invention may be used without the inclusion of the Bollinger bands.

A moving average with a fixed time period is calculated using the most recent price of the Bund 30 futures financial series. The updated value of the average is shown in the column headed “ave”. This moving average is used for calculating the standard deviation of the price of the financial series over the same number of price terms. The result of the standard deviation calculation is shown in the column “sd”. Bollinger bands are plotted at two standard deviations above and below the moving average. Thus the distance between the upper and lower Bollinger bands is a total of four standard deviations. This distance is shown in the box above the table and is labelled “Bollinger”. Under the headings “lower” and “upper”, the levels of the upper and lower Bollinger bands are also shown in this box

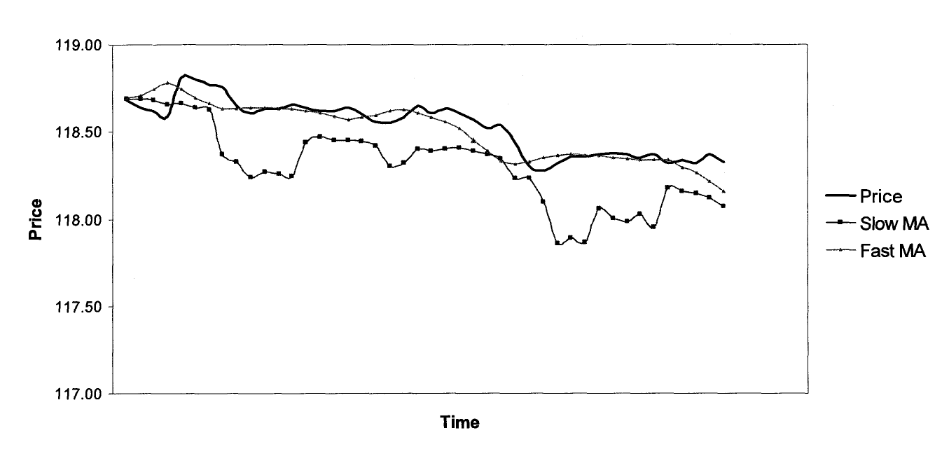

The levels of the moving averages and the price of the Bund 30 financial series have been plotted as a graph, as shown in FIG. 2. The slow moving average generally lags behind the price of the Bund 30 financial series. Whereas, the fast moving average tends to follow the actual price of the financial series more closely.

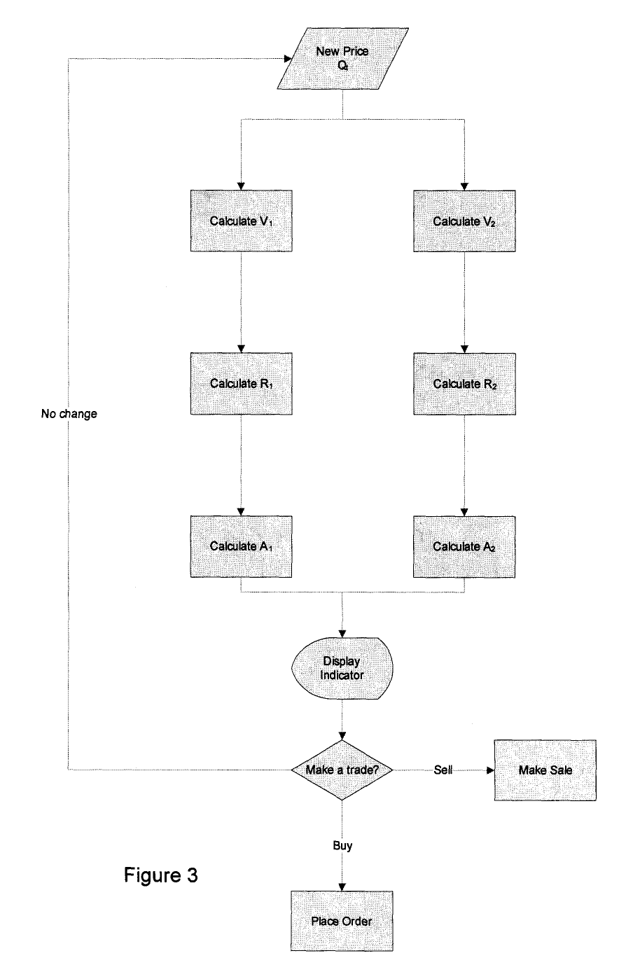

A flow illustration for trading on the price of a financial series using a method of the present invention is shown schematically in FIG. 3. The system is updated with the most recent price data (Qₜ) using a data provider. The system uses the new price data to calculate updated values for the volatility measures V₁ and V₂. These values are then used to calculate updated values for the time period ratios R₁ and R₂. R₁ and R₂ are then used to calculate a long or slow moving average and a short or fast moving average, which are shown in the diagram as A₁ and A₂. The system generates a trading indicator for that financial series, which is based on the relative positions of A₁ , A₂ and the most recent price Qₜ. If the system generates a no-trade signal, such as when the market is “flat”, then the no trade should be made. When a buy signal is generated, such as the “long” indicator in FIG. 1, the system generates an alert for the trader or may also be setup to automatically place an order to buy on that financial series. Similarly, the generation of a sell signal, such as the “short” indicator in FIG. 1, also generates an alert for the trader or the system may automatically make a sale on this particular financial series.

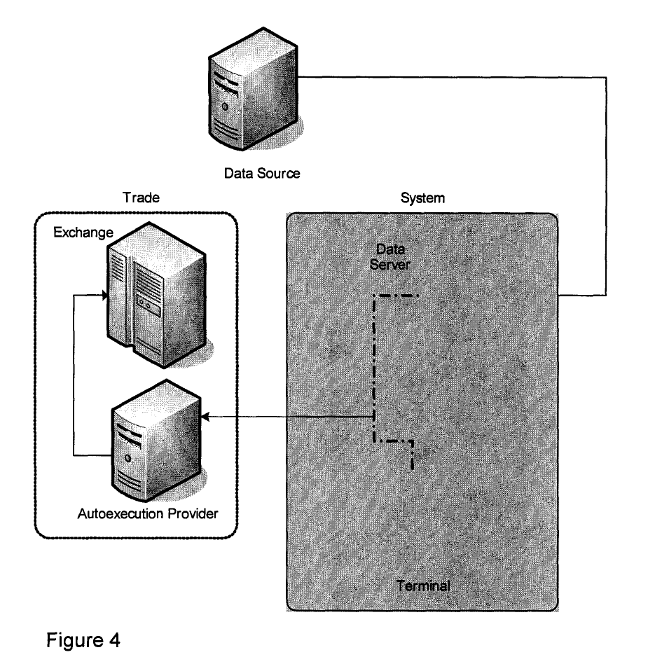

A scheme showing a networked computer system for using the method of the invention is illustrated in FIG. 4. The data server is networked to a data source. Price data for a financial series may be sent or retrieved from the data source to the data server. The data server may calculate a trading indicator of the invention based on the updated price information for a particular financial series obtained from the data source. The financial indicator or the alert may be displayed on a networked terminal. In FIG. 4, the system has been represented as the combination of the data server and the networked terminal.

A trader using a terminal may wish to execute a trade from his terminal. The trade may be executed by sending the request to the data server, which then uses its network connection to execute the trade. Alternatively, the terminal may have its own, independent network connection for executing trades. The trade is made by the system via an Autoexecution provider, which then connects to an Exchange.

1. A method for calculating a trading indicator for the price of a financial series, wherein the prices in said series are represented by Qₜ, Qₜ₋₁, Qₜ₋₂, Qₜ₋₃, . . . Qₜ₋ₓ, . . . ,Q_{t-y}, where Qₜ is the most recent price of said series and wherein Q_{t-y} represents a price of the series from a different time period to Qₜ₋ₓ, said method comprising the steps of:
(i) calculating a volatility measure VI of the financial series from the most recent price Qₜ and a previous price Qₜ₋ₓ,
(ii) calculating a second volatility measure V₂ of the financial series from the most recent price Qₜ and a previous price Q_{t-y},
(iii) calculating ratios R₁ and R₂, wherein R₁=M₁/V₁ and R₂=M₂/V₂ and where M₁ and M₂ are multipliers, such that one of R₁ or R₂ is larger than the other,
(iv) calculating a first price measure over a series of previous prices to the most recent price Qₜ, wherein said ratio R₁ is the number of price time periods of said first price measure,
(v) calculating a second price measure over a series of previous prices to the most recent price Qₜ, wherein said ratio R₂ is the number of price time periods of said second price measure, and wherein
said trading indicator is based on the first and second price measures.

2. A method according to claim 1, wherein the first price measure is a first moving average A₁ and the second price measure is a second moving average A₂.

3. A method according to claim 1, wherein the volatility measures V₁ and V₂ are each independently based on a formula for calculating a biased standard deviation, a non-biased standard deviation or is calculated using a formula given by (I)
$$V = std ( log ( \frac{{Q}_{t}}{{Q}_{t - x}} ) ) . \qquad ( I )$$

4. A method according to either claim 2, wherein said first and second moving averages A₁ and A₂ are calculated as a simple moving average, an exponential moving average, a triangular moving average or a weighted moving average.

5. A method according to claim 4, wherein said first and second moving averages A₁ and A₂ are simple moving averages.

6. A method according to claim 2, wherein one of A₁ or A₂ is a moving average calculated over a short time period and the other of A₁ or A₂ is calculated over a long time period.

7. A method according to claim 1, wherein the minimum value for the ratios R₁ and R₂ is at least 1.

8. A method according to claim 1, wherein said first and second price measures are volatility measures.

9. A method for calculating a trading indicator for the price of a financial series, wherein the prices in said series are represented by Qₜ, Qₜ₋₁, Qₜ₋₂, Qₜ₋₃, . . . Qₜ₋ₓ and where Qₜ is the most recent price of said series, comprising the steps of:
(i) calculating a volatility measure V₁ of the financial series from the most recent price Qₜ and a previous price Qₜ₋ₓ,
(ii) calculating a ratio R₁, wherein R₁=M₁/V₁ and where M₁ is a multiplier,
(iii) calculating a price measure over a series of previous prices to the most recent price Qₜ, wherein said ratio R₁ is the number of price time periods of said price measure, and wherein
said trading indicator is based on said price measure.

10. A method according to claim 9, wherein said price measure is a moving average A₁.

11. A method according to claim 9, wherein the volatility measure V₁ is based on a formula for calculating a biased standard deviation, a non-biased standard deviation or is calculated using a formula given by (I):
$${V}_{1} = std ( log ( \frac{{Q}_{t}}{{Q}_{t - x}} ) ) . \qquad ( I )$$

12. A method according to claim 10, wherein the moving average A₁ is calculated as a simple moving average, an exponential moving average, a triangular moving average or a weighted moving average.

13. A method according to claim 12, wherein the moving average is calculated as a simple moving average.

14. A method according to claim 9, wherein minimum value for the ratio R₁ is at least 1.

15. A method according to claim 9, wherein said price measure is a volatility measure.

16. A method for calculating a trading indicator for the price of a financial series, comprising the step of calculating a moving average over a time period on the price of a financial series, wherein said time period is inversely proportional to a volatility measure calculated on the price of said financial series.

17. A method for calculating a trading indicator for the price of a financial series, comprising the step of calculating a price measure over a time period on the price of a financial series, wherein said time period is inversely proportional to a volatility measure calculated on the price of said financial series.

18. An electronic financial trading system for buying or selling a financial series, wherein the prices in said series are represented by Qₜ, Qₜ₋₁, Qₜ₋₂, Qₜ₋₃, . . . Qₜ₋ₓ, . . . Q_{t-y}, where Qₜ is the most recent price of the financial series and where Q_{t-y} represents a price of the financial series from a different time period to Qₜ₋ₓ, said system comprising,
(i) means for calculating a volatility measure V₁ of the financial series from the most recent price Qₜ and a previous price Qₜ₋ₓ,
(ii) means for calculating a ratios R₁, wherein R₁=M₁/V₁ and where M₁ is a multiplier,
(iii) means for calculating a price measure over a series of previous prices to the most recent price Qₜ, wherein said ratio R₁ is the number of price time periods of said price measure,
and wherein
said system has means for generating a trading indicator based on said price measure.

19. A system according to claim 18, wherein said price measure is a moving average.

20. An electronic system according to claim 18, wherein the volatility measure V₁ is based on a formula for calculating a biased standard deviation, a non-biased standard deviation or is calculated using a formula given by (I)
$$V = std ( log ( \frac{{Q}_{t}}{{Q}_{t - x}} ) ) . \qquad ( I )$$

21. An electronic system according to claim 19, wherein said moving average A₁ is calculated as a simple moving average, an exponential moving average, a triangular moving average or a weighted moving average.

22. An electronic system according to claim 21, wherein said moving average A₁ is a simple moving average.

23. An electronic system according to claim 18, wherein the minimum value for the ratio R₁ is at least 1.

24. An electronic system according to claim 18, wherein said price measure is a volatility measure.

25. An electronic system according to claim 18, having a component for retrieving the most recent closing price of said financial series from a data source.

26. An electronic system according to claim 18, having a network connection that enables a user to buy or sell the a financial instrument or tradable commodity.

27. An electronic system according to claim 26, wherein said system uses a trading indicator to automatically buy or sell the financial instrument or tradable commodity.

28. Use of an electronic financial trading system according to claim 18, to buy or sell a financial instrument or tradable commodity.

29. A computer program for calculating a trading indicator which when run on a computer or computer network causes the computer or network to operate in accordance with a method according to claim 1.

30. A computer program product comprising a computer program according to claim 29 stored on computer readable media.

31. A computer program for calculating a trading indicator which when run on a computer or computer network causes the computer or network to operate in accordance with a method according to claim 9.

32. A computer program product comprising a computer program according to claim 31 stored on computer readable media.
